(19) United States
(12) Patent Application Publication
(10) Pub. No.: US 2004/0128379 A1
(43) Pub. Date: Jul. 1, 2004

(54) Collecting standard interval metrics using a randomized collection period

(76) Inventors: Jerry Mizell, Plano, TX (US); David Lauson, McKinney, TX (US); Steven Currin, McKinney, TX (US)

Correspondence Address: James A. Harrison, P.O. Box 670007, Dallas, TX, 75367, US

(21) Appl. No.: 10/334,667

(22) Filed: Dec. 30, 2002

(51) Int. Cl. G06F 15/173

(52) U.S. Cl. 709/224; 709/225

(57) ABSTRACT

A multi-processor system comprises a plurality of data plane processors for receiving and transmitting data to a plurality of end devices and a control processor for controlling and centralizing operation of the plurality of data plane processors and for reporting usage metrics externally, wherein the control processor is coupled to communicate with the plurality of data plane processors by way of a bus. The data plane processors collect usage metrics on a scheduled basis of a randomly determined period and report the usage metrics to the control processor at the end of the randomly determined period, wherein each randomly determined period includes a first portion and a second portion. Each data plane processor is assigned a randomly determined time period that is broken into first and second portions for which it is to report usage metrics at the termination of the randomly determined period. By assigning randomly determined periods to each data plane processor and by requiring each data plane processor to report at the end of its randomly determined period, the control processor receives usage metrics reports from each of the data plane processors in a distributed manner.

### BACKGROUND OF THE INVENTION

1. Technical Field of the Invention

The present invention relates generally to mobile communication systems and, more particularly, to general packet radio services for delivering data over a circuit switched telephone network.

2. Description of Related Art

A General Packet Radio Service (GPRS) is a non-voice value added service that allows information to be sent and received across a mobile telephone network. It supplements, or rides on top of, today's circuit switched data and Short Message Service (SMS) networks. The theoretical maximum speed of GPRS includes speeds of up to approximately 171.2 kilobits per second (kbps). This maximum speed is achievable in GPRS systems using all eight timeslots at the same time in a Time Division Multiple Access (TDMA) context.

This speed is about three times as fast as data transmission speeds possible over today's fixed telecommunication networks and ten times as fast as current circuit switched data services on Global System for Mobile Communications (GSM) standard TDMA networks. Thus, GPRS systems are advantageous in that they require less system resources to transmit a fixed amount of data in comparison to using a traditional circuit switched approach. By allowing information to be transmitted more quickly, immediately, and efficiently across the mobile network, GPRS may well be a relatively less costly mobile data service compared to SMS and circuit switched data services.

GPRS also facilitates instant connections in which information can be sent or received immediately as the need arises, subject to radio coverage. No dial-up modem connection is necessary. GPRS, similar to some broadband connections for personal computers, often is referred to as being “always connected”. Thus, another advantage of GPRS is that data may be transmitted immediately, whenever the need arises. In contrast to circuit switched data networks in which a connection must be established to transmit a data packet or data file, GPRS operation is extremely efficient in those situations in which a small amount of data is to be sent. As the emphasis of many designs today are to create wireless computer networks, and to connect data devices, including personal computers to wireless transceivers and mobile terminals, such a system that provides instantaneous response is very important for time critical applications and, more generally, for the implementation of wireless computer networks. For example, a remote credit card authorization system implemented in a wireless network can be greatly improved if it is unnecessary for the customer to wait the amount of time that is required to establish a connection. Additionally, GPRS facilitates the use of Internet applications not only from personal computers, but also from appliances and machines. It is anticipated that appliances will be designed to be coupled to the Internet to facilitate control either onsite or remotely. While some people envision connecting these appliances to a network port by physical lines, it would clearly be advantageous to be able to connect such appliances to the Internet through a wireless link. GPRS will facilitate the creation of Internet-controlled appliance networks through a wireless medium.

As suggested before, GPRS involves overlaying a packet based air interface on an existing circuit switched wireless network. For example, the circuit switched wireless network may comprise a GSM network. Accordingly, the user is given an option to utilize a packet based data service. In order to overlay a packet based air interface over a circuit switched network, the GPRS standard defines new infrastructure nodes to minimize the impact to existing networks in terms of hardware and software.

One advantage of GPRS is that the packet switching that results from the infrastructure nodes allows the use of GPRS radio resources only when users actually are sending or receiving data. Unlike traditional circuit switched voice networks, a connection is not continuously reserved for a user for the intermittent transmission of data. This efficient use of scarce radio resources means that a larger number of GPRS users can share the same bandwidth and be served from a single base station or cell. The actual number of users, of course, that may use the system at one time depends on the amount of data being transferred.

Another delivery network, namely, the Universal Mobile Telecommunications System (UMTS) network, also provides connectionless services. Moreover, GPRS and UMTS support push services. A push service is the delivery of data or multimedia information from a network node to user equipment for the purpose of activating the user equipment or for providing information from the network. A push service also can include activating a Packet Data Protocol (PDP) context, if necessary. Examples of delivery networks that offer push services include, as stated, the GPRS network, but can also include other equipment, such as a session initiation protocol (SIP) proxy, a push proxy or an SMS service center. Push services are expected to be popular because of their ability to deliver advertisements, as well as subscriber ordered upon notice such as traffic conditions, sports scores, stock quotes, etc. New services and features being contemplated require that push capabilities be implemented to enable external Internet protocol (IP) networks to deliver data to third generation wireless terminals in the paging system (PS) domain.

Packet domain utilized in GPRS and UMTS networks uses a packet-mode technique to transfer high speed and low speed data and signaling in an efficient manner and generally optimizes network and radio resources. Strict separation between the radio subsystems and network subsystems is maintained thereby allowing a network subsystem to be reused with other radio technologies. A common packet domain core network is used for both GPRS and UMTS. The common core network provides packet switched services and supports differing quality of service levels to allow efficient transfer of non-continuous bit rate traffic (for example, bursty data transfers).

Some specifications allow operators to provide push services by using static IP addresses or by having long lasting PDP context. However, it would be advantageous to also provide push services within systems that utilize dynamic IP addressing schemes. In other words, push services should be provided to any mobile terminal regardless of whether it has a static or dynamic IP address. In order to use dynamic IP addresses, it is necessary for the network to be able to initiate a PDP context for a mobile subscriber.

In GPRS and UMTS networks, however, a network-initiated PDP context activation is not practical unless a static IP address is allocated for the subscriber in some current systems. The use of static IP address assignments is cumbersome, however, because it wastes available address space for mobile subscribers that are inactive. Thus, it is desirable to initiate PDP context activation with dynamic address assignments. The use of dynamic assignment schemes means that a user's address is not predictable and known to all other systems. Accordingly, specific problems arise when a user wishes to establish a connection with another device without knowing the address of that device. Accordingly, systems are required that can ascertain the dynamic address of a terminating device for the creation of a connection or session.

An Access Point Name (APN) is a reference to a specific gateway GPRS support node (GGSN) that is to be used. Additionally, the APN may be used to identify the external network and even a service that is to be offered. The APN typically comprises two portions. A first portion carries the APN network identifier that serves as a label. This APN network identifier is a fully qualified domain name according to Domain Naming System (DNS) conventions. In order to guaranty the uniqueness of the APN, a packet domain Public Land Mobile Network (PLMN) allocates, to an Internet Service Provider (ISP) or corporation, an APN network identifier identical to their domain name in the public Internet. A second portion of the access point name is the APN operator identifier that is used optionally. It, too, is a fully qualified domain name according to DNS conventions. The APN is an APN network identifier for the selected APN in the Activate PDP Context Request message. The GGSN uses the APN to find an external network and, optionally, to activate a service for the APN. In some embodiment of the invention, the original Activate PDP Context Request message further includes a selection mode that indicates whether a subscribed APN was selected or a non-subscribed APN was selected.

Usage metrics are a vital part of any communication network and are required to facilitate billing and resource planning and management. While there are many types of billing arrangements, for example, a user is typically charged for data transmission in a data network in terms of a specified rate in relation to volume. Moreover, users often are provided an opportunity to pay different rates according to a specified quality of service, i.e., data rates and reliability. For example, a streaming data service will require greater throughput rates and reliability (on a per packet basis) than an email service in which retransmissions of lost data packets are not as problematic as they are for streaming data services in which lost packets can result in poor quality video or audio. Thus, usage metrics are an important part of properly billing a user for the service provided. Additionally, monitoring and providing usage metrics is important as a part of network management because the usage metrics enable a network manager to predict and respond to peak loading requirements for the present as well as the future.

One specific problem is that current usage metrics generating schemes occurs in multiprocessor environments. For example, if a system such as a gateway GPRS support node includes a control processor that is coupled to receive usage metrics from each of a large plurality of data plane processor cards there within the GGSN at a specified time so that the control card can generate a corresponding report including usage metrics, the control card, as well as the internal network buses of the GGSNs, are likely to become overloaded with data.

There is a need, therefore, for a system and method that provides for usage metrics reporting from each of the large plurality of data plane processors in a way that avoids traffic congestion within the GGSN.

### BRIEF SUMMARY OF THE INVENTION

A multi-processor system comprises a plurality of data plane processors for receiving and transmitting data to a plurality of end devices and a control processor for controlling and centralizing operation of the data plane processors and for reporting usage metrics externally, wherein the control processor is coupled to communicate with the plurality of data plane processors by way of a bus. The data plane processors collect usage metrics on a scheduled basis of a randomly determined period and report the usage metrics to the control processor at the end of the randomly determined period, wherein each randomly determined period includes a first portion and a second portion. Each data plane processor is assigned a randomly determined time period for which it is to report usage metrics. The data plane processors report the usage metrics at the termination of the randomly determined period. By assigning randomly determined periods to each data plane processor and by requiring each data plane processor to report at the end of its randomly determined period, the control processor receives usage metrics reports from each of the data plane processors in a distributed manner. In the described embodiment of the invention, the randomly determined periods are further broken into first and second portions (or “buckets”) for reporting purposes.

The control processor, therefore, receives the usage metrics at the end of the randomly determined period for each of the plurality of data plane processors and, responsive thereto, generates a system report defining usage metrics of all of the data plane processors within the multi-processor system at defined time intervals (e.g., time of day intervals). The first and second portion of the randomly determined period are sized to correspond with the defined time interval (e.g., the time of day interval). More specifically, the first portion is sized to terminate on the defined time interval (or time of day interval) while the second portion is sized to begin on the defined time interval (or time of day interval). Additionally, the first and second portion are time tagged to enable the control processor to generate its report. At the end of the randomly determined period assigned to each data plane processor, each of the data plane processors generates its usage metrics report to the control processor. The control processor then generates a usage metrics report for all of the data plane processors by examining the time tags for each portion received from each data plane processor to create a report that includes usage metrics for a defined window of time. In one embodiment of the invention, the defined window of time is a preceding period between the defined time intervals.

The present invention is advantageous in that it realizes benefits of randomly distributing reporting from the data plane processors while providing a mechanism to enable a control processor to generate usage metrics reports for fixed time intervals.

### BRIEF DESCRIPTION OF THE SEVERAL VIEWS OF THE DRAWINGS

FIG. 1 is a functional block diagram of a communication network formed according to one embodiment of the present invention;

FIG. 2 is a functional block diagram of a multi-processor system formed according to one embodiment of the present invention;

FIG. 3 is a timing diagram showing usage metrics collection and reporting according to one embodiment of the present invention;

FIG. 4 is a timing diagram illustrating the relationship between randomly determined periods and defined time periods;

FIG. 5 is a functional block diagram of a data plane processor card of a plurality of data plane processor cards and a control processor card within a gateway GPRS support node; and

FIG. 6 is a flowchart that illustrates one method for collecting and reporting usage metrics according to one embodiment of the present invention.

### DETAILED DESCRIPTION OF THE INVENTION

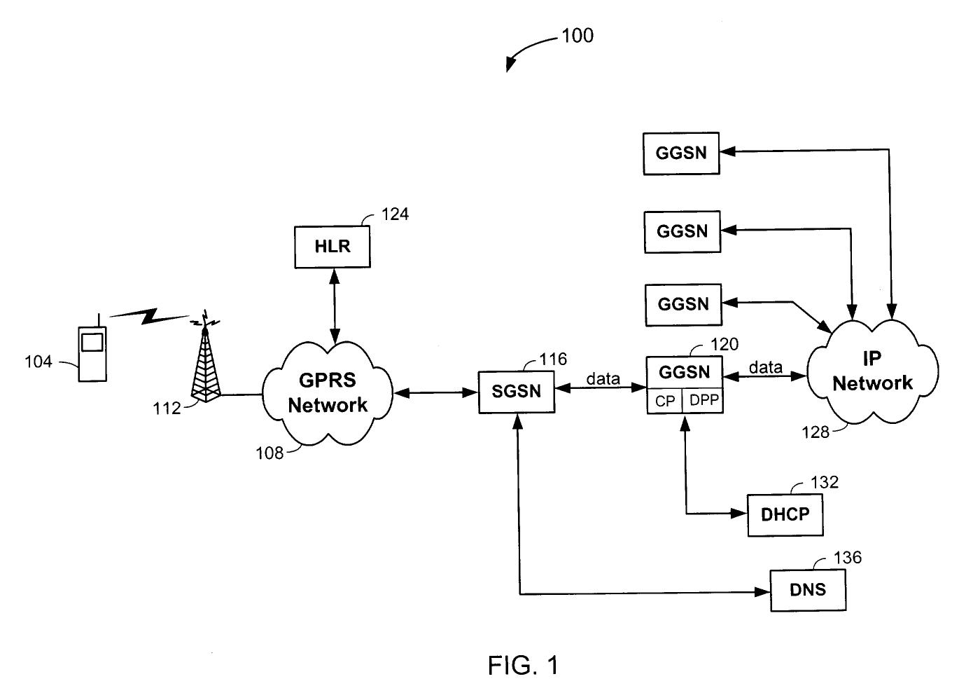

FIG. 1 is a functional block diagram of a communication network formed according to one embodiment of the present invention. The communication network shown generally at 100 includes a mobile terminal 104 that communicates with radio equipment formed within a GPRS network 108 by way of a tower 112. Mobile terminal 104 is a GPRS-capable and voice-capable mobile terminal. The GPRS network 108 includes a serving GPRS support node (SGSN) 116 that is operatively coupled to a gateway GPRS support node (GGSN) 120. Additionally, a Home Location Register (HLR) 124 is coupled to GPRS network 108 to provide subscriber information, and other types of information as necessary, to GGSN 120. HLR 124 contains subscriber information for both GPRS and UMTS networks. An SGSN, such as SGSN 116, is for communicating with a mobile node to initiate a data session or connection through a wireless data packet network. By analogy, the functionality of an SGSN may be compared to that of a base station controller in a voice network. A GGSN, such as GGSN 120, provides a gateway, as its name suggests, from the wireless data packet network to a traditional data packet network such as an IP network. Thus, as may be seen, GGSN 120 is operatively coupled to an IP network 128.

Generally, the SGSN monitors an individual mode location and performs related functions such as access control. The SGSN is connected to the GSM base station through the Gb interface and/or to the UMTS radio access network through the lu interface. The GGSN provides interworking with external packet switched networks that is connected to SGSNs via an IP-based packet domain backbone network. Generally, the GGSN provides an interface between the GPRS network and an external packet switched network.

User data is transferred transparently between the mobile terminal and external data networks by using encapsulation and tunneling techniques. The data packets are equipped with specific protocol information and are transferred between the mobile terminal and the GGSN. This transparent transfer method lessens requirement to interpret external data protocols and facilitates introduction of additional interworking protocols.

GGSN 120 further is coupled to a Dynamic Host Configuration Protocol (DHCP) server 132 while SGSN 116 is operatively coupled to a Domain Naming System (DNS) server 136. The DHCP server 132 is a TCP/IP protocol that enables personal computers and workstations to obtain temporary or permanent IP addresses to use for routing communication signals. Typically a DHCP server communicates with DHCP clients to dynamically assign IP addresses to terminals whenever needed. DHCP supports manual, automatic and dynamic address assignment and provides the client sub-net mask gateway addresses and DNS addresses. A DHCP server verifies a device identity and “leases” to it an IP address on a dynamic basis for use for a specified amount of time. Thereafter, the leased address is reclaimed for reassignment. A DNS server includes a plurality of distributed databases that translate computer names to specific IP addresses. A typical DNS server facilitates use of the Internet without requiring one to memorize or remember a long list of numbers. Thus, DNS servers and the DNS make it easy to remember an address of a particular destination.

IP network 128 also is coupled to a plurality of GGSNs, including GGSN 120. GGSN 120 forms the gateway between IP network 128 and GPRS network 108 that is presently serving mobile terminal 104. Continuing to examine FIG. 1, GGSN 120 also is coupled to HLR 124. In the diagram shown, other GGSNs are shown within network 100 merely to show their presence, but they are not providing any communication support for the present example and, more particularly, for mobile terminal 104. Each of the plurality of GGSNs and HLR 124 are a part of GPRS network 108.

As will be described in greater detail below, the network 100 further includes GGSN 120 that, as described herein, will provide a portion of the actual PDP context, meaning that the connection or data session will pass through it. In general, GGSN 120 is the GGSN identified to provide the active context by DNS server 136. In operation, whenever mobile terminal 104 seeks to establish a connection or data session, it generates an Activate PDP Context Request message through tower 112 and GPRS network 108 to SGSN 116. The Activate PDP Context Request message includes an APN.

SGSN 116 then communicates with DNS 136, by sending a query to DNS 136, to identify a GGSN that is to provide the active context. For the example herein, DNS 136 provides an identifier that specifies that GGSN 120 is to support the active context that is being set up. Accordingly, SGSN 116 generates a Create PDP Context Request message to GGSN 120. Here, because the context is being created to a remote network, GGSN 120 generates a query to a DHCP server 132 to obtain an address for the PDP context that is being established.

For the present example, DHCP server 132 returns an address to GGSN 120 that is managed or supported by GGSN 120. Accordingly, GGSN 120 is able to establish the PDP context for mobile terminal 104.

Each GGSN 120 typically comprises a multi-processor environment that includes a control processor and a large plurality of data plane processors coupled thereto by way of an internal bus (or a plurality of internal buses). The data plane processors process user data packets for transmission between the SGSN and the IP network as illustrated in FIG. 1. Accordingly, for proper billing and network management, the GGSN generates reports including usage metrics to at least one external server or device. In the described embodiment of the invention, the data plane processors collect and report usage metrics to the control processor during randomly determined periods and the control processor generates usage metrics reports for the data plane processors at defined time intervals.

Examples of the types of user metrics that are collected in one embodiment of the invention include the number of bytes transferred per PDP context, the number of bytes transferred per protocol, such as HTTP or TCP, the number of bytes transferred per APN, the number of bytes discarded per PDP context, and the number of bytes discarded per APN.

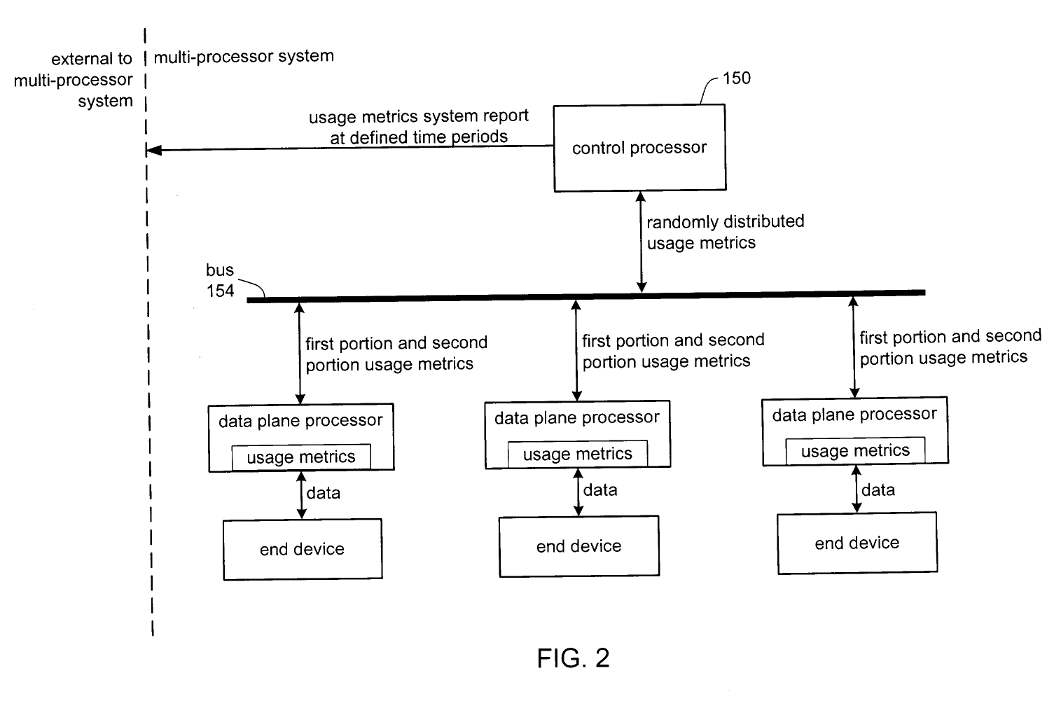

FIG. 2 is a functional block diagram of a multi-processor system formed according to one embodiment of the present invention. A control processor 150 is operably coupled to a plurality of data plane processor by way of bus 154. Each data plane processor of the plurality of data plane processors receives and transmits data to an end device. Each data plane processor of the plurality of data plane processors collects usage metrics during a randomly determined period and, at the end of the randomly determined period, reports the collected usage metrics to the control processor 150. Each data plane processor of the plurality of data plane processors has a different (in all probability) randomly determined period so the control processor 150 receives the usage metrics in a randomly distributed manner. The control processor 150 reports the received usage metrics at defined time periods to a device external to the multi-processor system. By design, each randomly determined period overlaps the control processor defined time period by a random interval. This overlap is used to divide the randomly determined period into a first portion and a second portion, the first portion and second portion having time stamp information contained therein enabling the control processor 150 to report usage metrics correlated to time-of-day for reporting node utilization, billing and accounting information. Accordingly, the control processor randomly receives usage metrics at the end of the randomly determined period for each data plane processor wherein the usage metrics are grouped into a first and second portion. Additionally, the first and second portions are both time stamped. Thus, the control processor is able to recombine received user metrics to generate system wide usage reports that are grouped according to defined time periods. In the described embodiment of the invention, the usage reports generated by the control processor group all first and second portions of user metrics received from the data plane processors that include user metrics of a specified preceding interval between defined time periods.

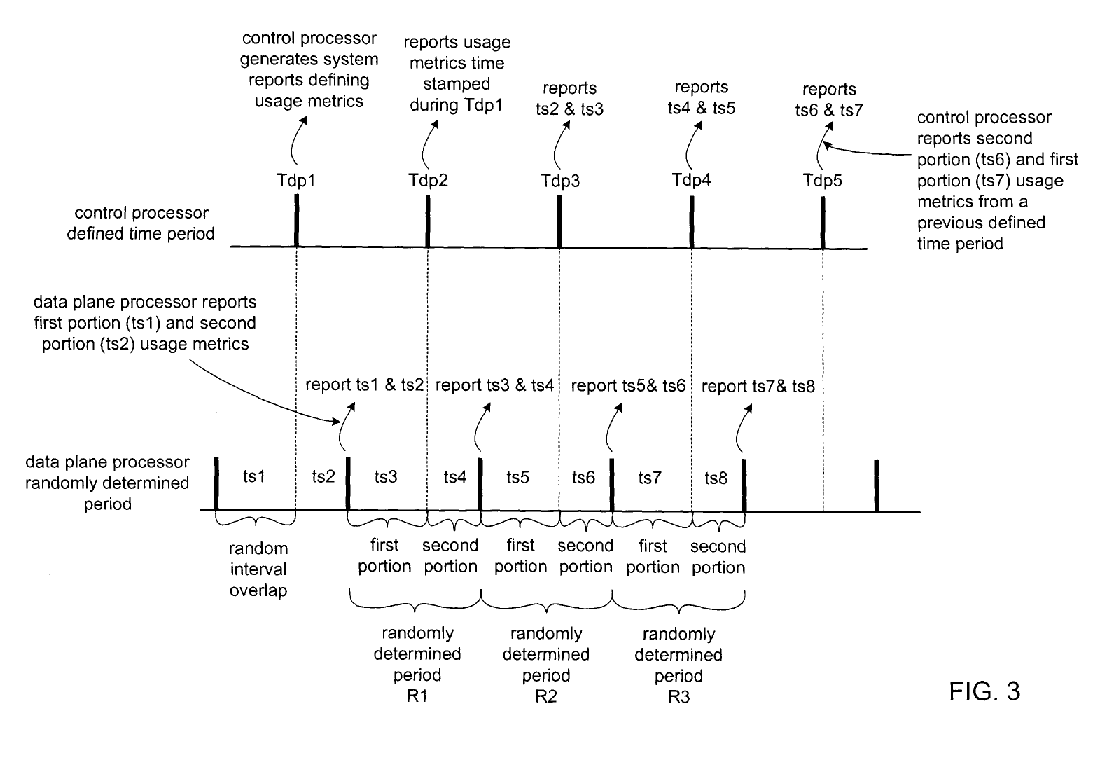

FIG. 3 is a timing diagram showing usage metrics collection and reporting according to one embodiment of the present invention. A data plane processor collects usage metrics during a randomly determined period and reports the usage metrics back to a control processor at the end of the randomly determined period. As shown in FIG. 3, the randomly determined periods overlap control processor defined (time-of-day interval) time periods. The present invention overcomes the limitations of the prior art by creating a first portion and a second portion for each of the randomly determined periods that ends and begins (respectively) on one of the defined time periods. The data plane processor starts to collect usage metrics by opening and time stamping a first portion ts3 of randomly determined period R1. Usage metrics collected include information such as number of bytes transferred, interval statistics, and account and billing information. At defined time period Tdp2, the data plane processor closes the first portion ts3 and opens and time stamps a second portion ts4. The data plane processor continues to collect usage metrics during the second portion until the end of randomly determined period R1. At the end of randomly determined period R1, the data plane processor closes second portion ts4 and reports the usage metrics for first portion ts3 and second portion ts4 to the control processor. The data plane processor repeats the first portion and second portion usage metrics collection in a plurality of randomly determined periods. The usage metrics reported to the control processor at the end of randomly determined period R1 contains usage metrics time stamped during two defined time periods, namely, Tdp2 and Tdp3. In order to report meaningful network statistics, the system reports generated by the control processor should contain usage metrics aligned to the same defined time periods. This allows the network to evaluate node utilization for a plurality of nodes correlated to the same time-of-day intervals. The control processor collects the first portion usage metrics ts3 and collects the second portion usage metrics ts2 reported at the end of a previous randomly determined period. Usage metrics ts2 and ts3 contain time stamps from defined time period Tdp2 so the control processor will generate a system report for defined time period Tdp2. This method allows the plurality of data plane processor to report usage metrics on a random basis thereby preventing the time-of-day control processor utilization spikes of the prior art while maintaining the desirable time-of-day correlation. In the event of heavy network traffic, the control processor can delay the system report without loss of integrity due to the time correlated usage metrics.

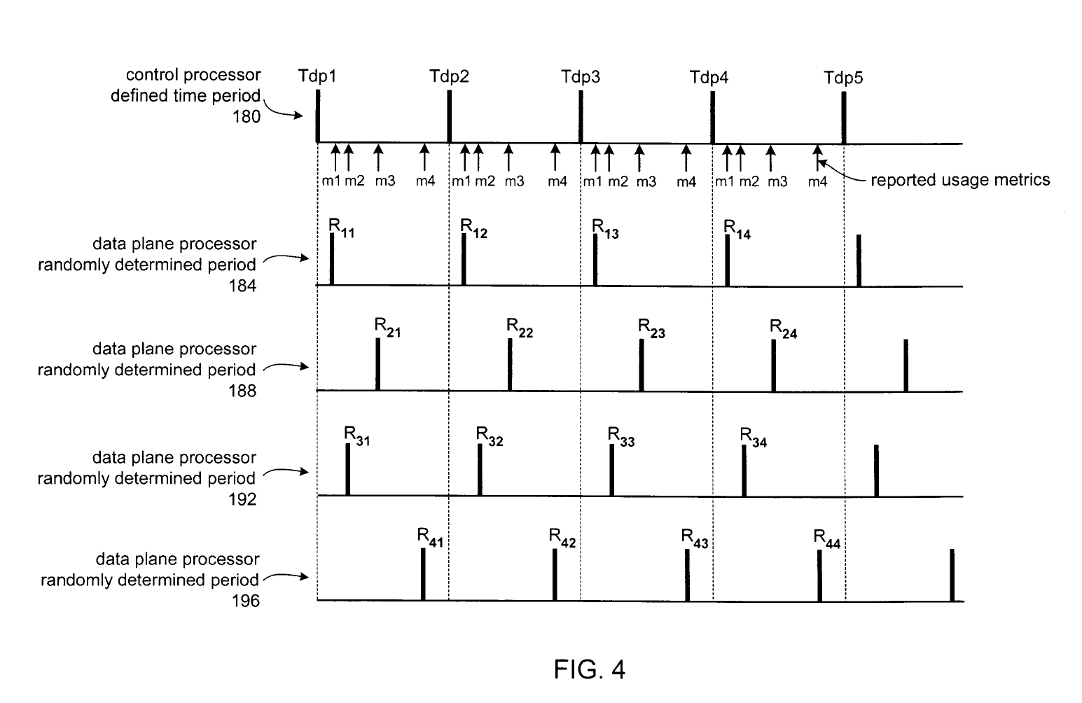

FIG. 4 is a timing diagram illustrating the random reporting of usage metrics from a plurality of data plane processors. Each data plane processor of the plurality of data plane processors has a different random interval that overlaps a control processor defined time periods 180, namely, defined time periods Tdp1, Tdp2, Tdp3, Tdp4 and Tdp5. The random distribution of reported usage metrics over the control processor defined time periods 180 reduces the control processor peak processing by spreading the processing over a larger time period. As shown in FIG. 4, data plane processor randomly determined period 184 reports usage metrics m1 at randomly determined period R₁₁, R₁₂, R₁₃ and R₁₄. In a similar manner, each data plane processor randomly determined periods 188-196 report usage metrics m2-m4 at random intervals during defined time periods Tdp 1, Tdp2, Tdp3, Tdp4 and Tdp5. As the number of data plane processors served by each control processor grows, processing load on the control processor will regress to a mean work load, substantially reducing the peak processing load experienced by prior art designs. Stated another way, if each data plane processor of the plurality of data plane processors reported usage metrics at the defined time period on a time-of-day schedule, then the control processor would experience an intense processing requirement which would negatively impact network subscriber throughput.

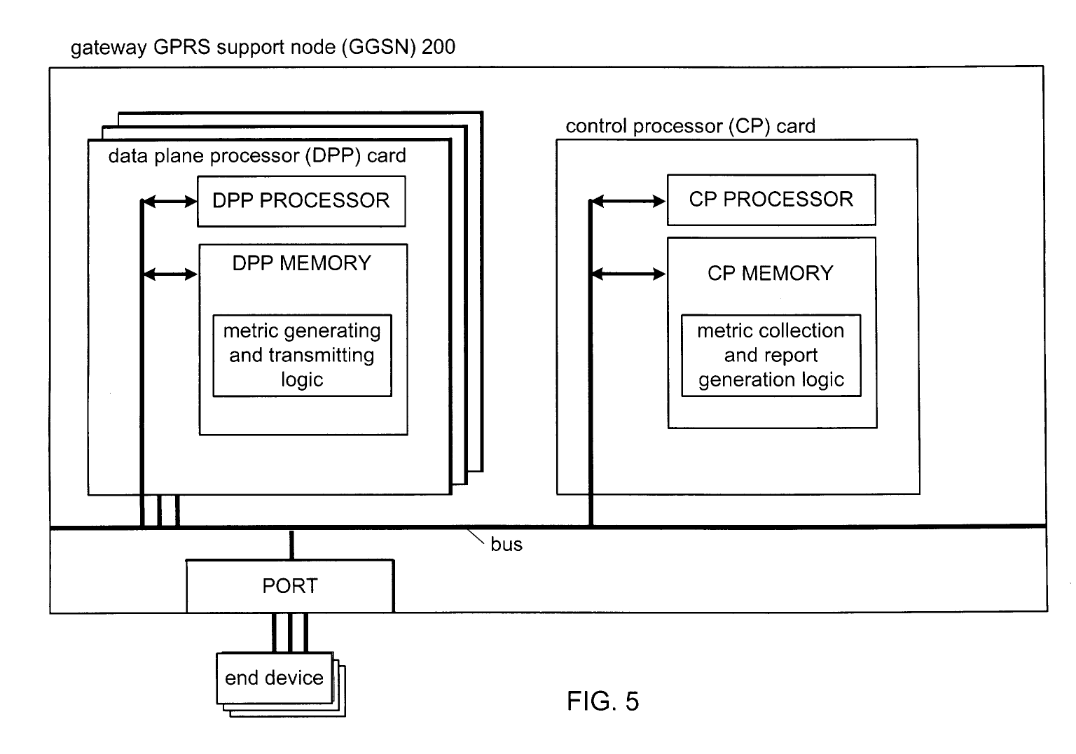

FIG. 5 is a functional block diagram of a data plane processor card of a plurality of data plane processor cards and a control processor card within a gateway GPRS support node (GGSN) 200. A data plane processor card 204 and a control processor card 208 are operably coupled to a bus 212. The data plane processor card 204 transmits and receives data, via bus 212, with an end device 216, which is typically a node in a distributed architecture network.

The data plane processor card 204 contains a data plane processor memory, operably coupled to bus 212, that contains computer instructions stored in the data plane processor memory that define routine operational logic to collect end device usage metrics on a randomly determined period and transmit the collected usage metrics to a control processor, by way of bus 212, at the end of the randomly determined period. The memory can be formed in any known method such as static and dynamic random access memory (RAM), or flash memory as is know to one of average skill in the art. A data plane processor, operably coupled to bus 212, performs operations to open and close a first portion and a second portion of the randomly determined period, as well as generate time stamps for the first and second portions. The data plane processor may be formed as a microprocessor, microcontroller, application specific integrated circuit (ASIC), or field programmable gate arrays (FPGA). According to process instruction contained internally or stored in data plane processor memory, the data plane processor opens a first portion of the randomly determined period at the start of the randomly determined period and closes the first portion at a defined time period. The data plane processor further opens a second portion of the randomly determined period at the defined time period and closes the second portion at the end of the randomly determined period. The time stamped first and second portion usage metrics are then transmitted to the control processor card 208 at the end of the randomly determined period.

The control processor card 208 contains a control processor memory, operably coupled to bus 212, that contains computer instructions stored in the control processor memory that define routine operational logic to collect usage metrics generated by the plurality of data plane processor cards on a randomly determined period and generate system usage reports on a specified time-of-day schedule. The memory can be formed in any known method, such as static and dynamic random access memory (RAM), or flash memory, as is known to one of average skill in the art.

Control processor card 208 further comprises a control processor operably coupled to bus 212. The control processor may be formed as a microprocessor, microcontroller, application specific integrated circuit (ASIC), or field programmable gate arrays (FPGA). The control processor, operating on defined time periods, generates system reports to enable a gateway GPRS node (GGSN) to report system usage metrics on a specific time-of-day schedule. The reported system usage metrics are useful in determining network performance metrics and generating time-of-day billing information. Network performance metrics are necessary to evaluate network operation but, to be meaningful, the collection periods for each node in the network needs to be aligned to the same time period. By randomly reporting the usage metrics across a defined time period, reported usage metrics can be time aligned without the processing burden of time-of-day boundary reporting.

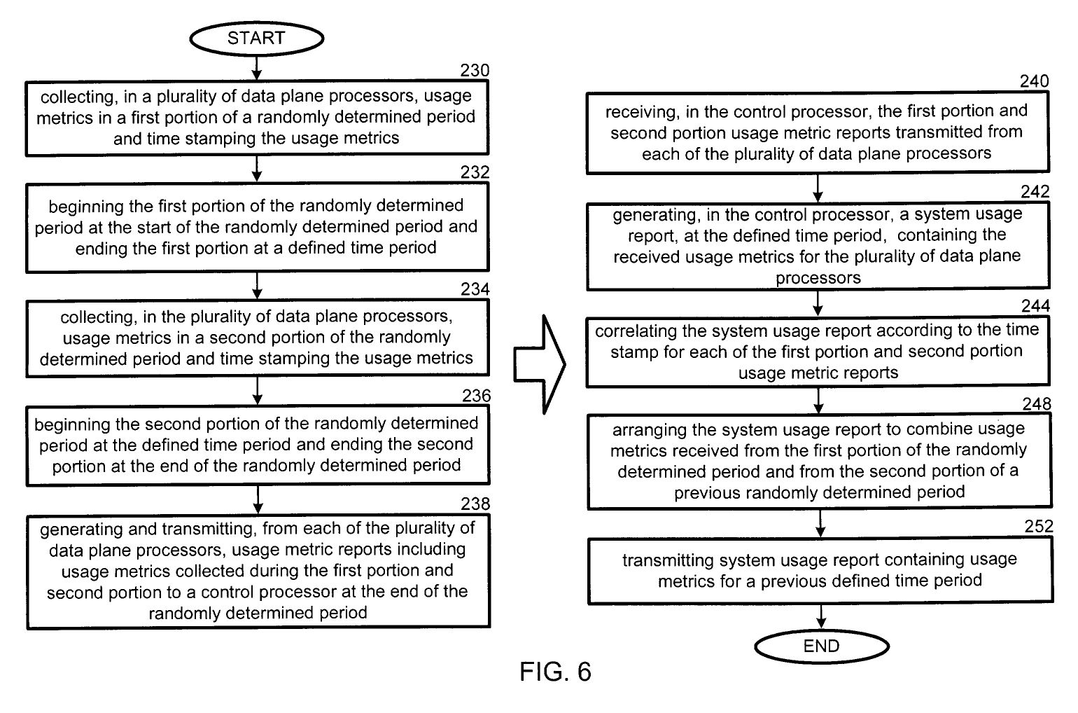

FIG. 6 is a flowchart that illustrates one method for collecting and reporting usage metrics according to one embodiment of the present invention. In a plurality of data plane processors, usage metrics are collected and, in one embodiment of the invention, are time stamped (to indicate when collected) during a first portion of a randomly determined period (step 230). More specifically, the first portion of the randomly determined period (for collecting usage metrics) begins at the start of the randomly determined period and ends at a defined time period (step 232). Thus, usage metrics are collected, in step 232, from the beginning of the randomly determined period until the defined time period. The first portion is time stamped when it is started to enable usage metrics from the plurality of data plane processors to be correlated.

At the end of the first portion of the randomly determined period, the invention includes collecting, in the plurality of data plane processors, usage metrics in a second portion of the randomly determined period and time stamping the usage metrics (step 234). The process includes beginning the second portion of the randomly determined period at the defined time period and ending the second portion at the end of the randomly determined period (step 236). The random interval of the randomly determined period ensures that each randomly determined period will overlap the defined time period by a random interval. Usage metric reports are generated from the usage metrics collected in the first and second portions of the randomly determined period. The usage metrics reports are then generated and transmitted from each of the plurality of data plane processors to a control processor at the end of the randomly determined period, the usage metric reports including usage metrics collected during the first portion and second portion (step 238). The randomly determined period in each of the plurality of data plane processors keeps the control processor from being overloaded by a plurality of generated reports arriving at the defined time period. The control processor receives usage metric reports from the plurality of data plane processors, including the first and second portions of the usage metric reports (step 240) and generates a system usage report at the defined time period, including usage metrics from all of the data plane processors that reported usage metrics during the defined time period (step 242). The control processor will time correlate the received system usage report by to the time stamp contained within each first and second portion of the transmitted reports (step 244). Due to the randomly determined period random interval overlap of the defined time period, usage metrics received by the control processor will contain usage metrics from the current defined time period and a previous defined time period. The control processor arranges the system usage report to combine usage metrics received from the first portion of the randomly determined period and from the second portion of a previous randomly determined period (step 248). The system usage report contains usage metrics for the previous defined time period and is then transmitted by the control processor to an external device (step 252).

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims. As may be seen, the described embodiments may be modified in many different ways without departing from the scope or teachings of the invention.

What is claimed is:

1. A multi-processor system, comprising:
a plurality of data plane processors for receiving and transmitting data to a plurality of end devices;
a bus coupled to each of the plurality of data plane processors;
a control processor for controlling and centralizing operation of the plurality of data plane processors and for reporting usage metrics externally, wherein the control processor is coupled to communicate with the plurality of data plane processors by way of the bus;
wherein each of the plurality of data plane processors collects usage metrics on a scheduled basis of a randomly determined period and reports the usage metrics to the control processor at the end of the randomly determined period, wherein each randomly determined period includes a first portion and a second portion; and
wherein the control processor receives the usage metrics at the end of the randomly determined period for each of the plurality of data plane processors and, responsive thereto, generates a system report defining usage metrics of all of the plurality of data plane processors within the multi-processor system.

2. The multi-processor system of claim 1 wherein the first portion and second portion of the randomly determined period contain time stamp information.

3. The multi-processor system of claim 1 wherein the system report is generated at defined time periods.

4. The multi-processor system of claim 3 wherein each randomly determined period overlaps the defined time period by a random interval.

5. The multi-processor system of claim 3 wherein the system report generated at defined time periods contains usage metrics reported during the first portion of the randomly determined period and during the second portion of a previous randomly determined period.

6. The multi-processor system of claim 3 wherein the system report generated at defined time periods contains usage metrics retrieved during a previous defined time period.

7. The multi-processor system of claim 6 wherein the control processor generates system reports for the previous defined time period by evaluating the time stamp information corresponding to the received usage metrics.

8. The multi-processor system of claim 3 wherein the first portion of the randomly determined period terminates on, and the second portion of the randomly determined period begins on, one of the defined time periods.

9. A method in a multi-processor system, comprising:
collecting, in a plurality of data plane processors, usage metrics in a first portion of a randomly determined period;
collecting, in the plurality of data plane processors, usage metrics in a second portion of the randomly determined period;
generating and transmitting, in each of the plurality of data plane processors, the first portion and second portion usage metric reports to a control processor at the end of the randomly determined period;
receiving, in the control processor, the first portion and second portion usage metric reports transmitted from each of the plurality of data plane processors; and
generating, in the control processor, a system usage report, at a defined time period, containing the received usage metrics for the plurality of data plane processors.

10. The method of claim 9 wherein the system usage report is time correlated according to a time stamp contained within each of the first portion and second portion usage metric reports.

11. The method of claim 9 wherein the first portion of the randomly determined period begins at the start of the randomly determined period and ends at the defined time period.

12. The method of claim 9 wherein the second portion of the randomly determined period begins at the defined time period and ends at the end of the randomly determined period.

13. The method of claim 9 wherein the generated system usage report contains usage metrics for a previous defined time period.

14. The method of claim 13 wherein the generated system usage report contains usage metrics received from the first portion of the randomly determined period and from the second portion of a previous randomly determined period.

15. A gateway GPRS support node (GGSN) control processor card, comprising:
a processor;
a bus coupled to the processor;
a memory, coupled to the bus, including computer instructions that define routine operational logic, the computer instructions further defining logic to:
collect usage metric information generated by a plurality of data plane processors on a randomly determined period; and
generate system usage reports in relation to defined time periods to enable the GGSN control processor card to report system usage metrics on a specified time-of-day schedule.

16. The gateway GGSN control processor card of claim 15 wherein the usage metrics information is collected in a plurality of portions, each of the plurality of portions being time stamped to enable usage metrics to be correlated with the specified time-of-day schedule.

17. The gateway GGSN control processor card of claim 15 wherein the step of generating system usage reports includes combining a second portion having a first time stamp with a first portion having a second time stamp wherein the first and second time stamps are not equal.

18. A gateway GPRS support node (GGSN) data plane processor card, comprising:
a processor;
a bus coupled to the processor;
a memory, coupled to the bus, including computer instructions that define routine operational logic, the computer instructions further defining logic to:
collect usage metrics for a randomly determined period; and
transmit, to a control processor card, the collected usage metrics at the end of the randomly determined period wherein the usage metrics are collected in portions that are sized as a function of defined time periods.

19. The GGSN data plane processor card of claim 18 wherein the collected usage metrics portions further include at least a first portion and at least a second portion, wherein the at least first portion begins collecting usage metrics at the start of the randomly determined period and stops collecting usage metrics at a defined time period, and wherein the at least second portion begins collecting usage metrics at the defined time period and stops collecting usage metrics at end of the randomly determined period.

20. The GGSN data plane processor card of claim 19 wherein the collected usage metrics portions are time stamped to enable collected usage metrics to be correlated with a specified time-of-day schedule.
